(19) United States
(12) Patent Application Publication
(10) Pub. No.: US 2007/0280271 A1
(43) Pub. Date: Dec. 6, 2007

(54) Communication apparatus and communication method

(75) Inventor: Shigeru Maeda, Tachikawa-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/806,411

(22) Filed: May 31, 2007

(30) Foreign Application Priority Data
May 31, 2006 (JP) 2006-151581

(51) Int. Cl. H04L 12/56

(52) U.S. Cl. 370/400

(57) ABSTRACT

According to one embodiment, provided is a communication apparatus including a reading unit which reads content data from a storage medium, a communication unit which communicates with a first external unit and a second external unit via network, a notifying unit which notifies, via the communication unit, the first external unit of position information for accessing content data that is readable by the reading unit, and a moving unit which moves the content data read by the reading unit to the second external unit via the communication unit, wherein after the moving unit moves the content data to the second external unit, the notifying unit notifies, via the communication unit, the first external unit of position information concerning the second external unit for accessing the content data as position information of the content data.

### CROSS-REFERENCE TO RELATED APPLICATION

This application is based upon and claims the benefit of priority from Japanese Patent Application No. 2006-151581, filed May 31, 2006, the entire contents of which are incorporated herein by reference.

### BACKGROUND

1. Field

One embodiment of the present invention relates to a communication apparatus and communication method for notifying an external apparatus of position information for accessing content data.

2. Description of the Related Art

In recent years, generally digital network technology has been prevailing, and a number of communication apparatuses using the digital network have been developed. Further, technology for moving content data over network in such a network communication environment has been known.

However, if after content data is moved to another device, a user forgets which device the content data has been moved to or another user moves the content data, the user needs to search for the device in which that content data is stored, one by one.

Patent document 1 (Jpn. Pat. Appln. KOKAI Publication No. 2004-234158) has disclosed a system in which inherent identifier information corresponding to content is set as property information in a content providing server, and even if move of content data between different servers occurs, a client can acquire the content data.

According to the above-described system, however, all the servers manage identification information of all contents, and thus burden of the server is very heavy. Particularly, it is difficult to automatically allocate identifier information to all the content data existing on network, and the load on the server is large.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of a configuration of a communication apparatus according to an embodiment of the present invention;

FIG. 2 is an explanatory diagram showing an example of communication among a plurality of communication apparatuses according to the embodiment of the invention;

FIG. 3 is an explanatory diagram showing an example of content information handled by the communication apparatus according to the embodiment of the invention;

FIG. 4 is an explanatory diagram showing an example of the content information handled by the communication apparatus according to the embodiment of the invention;

FIG. 5 is an explanatory diagram showing an example of the content information handled by the communication apparatus according to the embodiment of the invention;

FIG. 6 is a flow chart showing an example of an address change notification processing after content data is moved in the communication apparatus according to the embodiment of the invention; and

FIG. 7 is a flow chart showing an example of the address change processing corresponding to the address change notification in the communication apparatus according to the embodiment of the invention.

### DETAILED DESCRIPTION

Various embodiments according to the invention will be described hereinafter with reference to the accompanying drawings. In general, according to one embodiment of the invention, a communication apparatus comprising: a reading unit which reads content data from a storage medium; a communication unit which communicates with a first external unit and a second external unit via network; a notifying unit which notifies, via the communication unit, the first external unit of position information for accessing content data that is readable by the reading unit; and a moving unit which moves the content data read by the reading unit to the second external unit via the communication unit, wherein after the moving unit moves the content data to the second external unit, the notifying unit notifies, via the communication unit, the first external unit of position information concerning the second external unit for accessing the content data as position information of the content data.

An embodiment of the present invention provides a communication apparatus and communication method capable of utilizing content data with a relatively light load even if the content data has been moved.

According to an embodiment of the invention, there is provided a communication apparatus comprising: a reading unit (20) which reads content data from a storage medium (D, 18); a communication unit (11) which communicates with a first external unit and a second external unit via network (L); a notifying unit (43) which notifies, via the communication unit, the first external unit of position information for accessing content data that is readable by the reading unit; and a moving unit (30) which moves the content data read by the reading unit (20) to the second external unit via the communication unit, wherein after the moving unit moves the content data to the second external unit, the notifying unit notifies, via the communication unit, the first external unit of position information concerning the second external unit for accessing the content data as position information of the content data.

As a result, even if the content data has been moved, the communication apparatus and communication method capable of utilizing the content data with a relatively light load can be provided.

Hereinafter, the embodiment of the present invention will be described in detail with reference to the drawings.

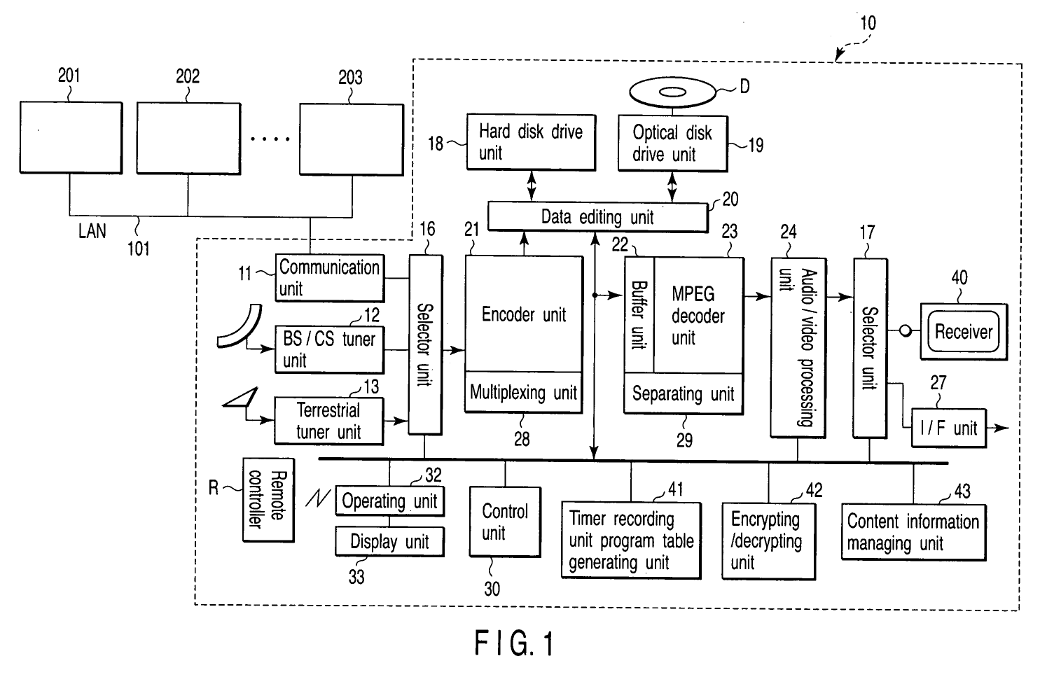

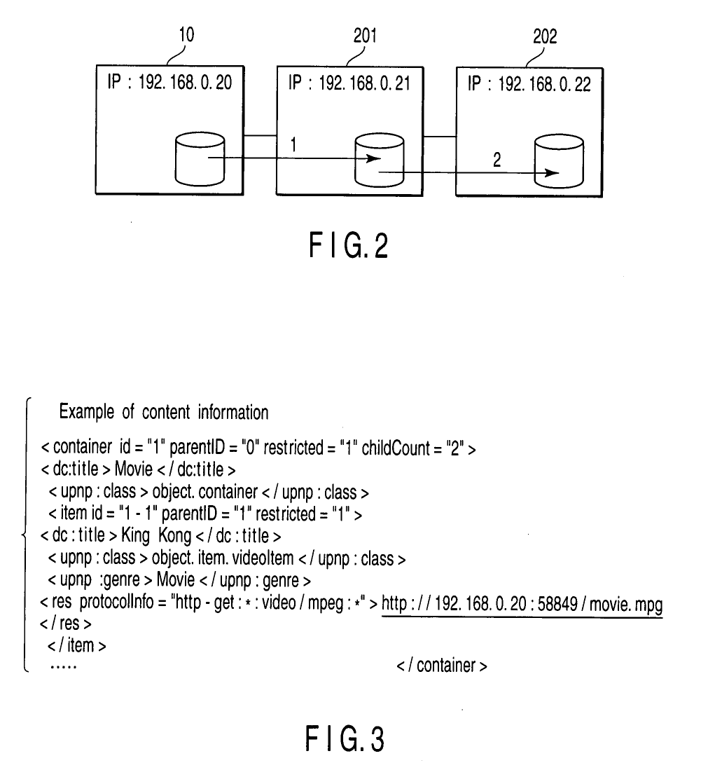

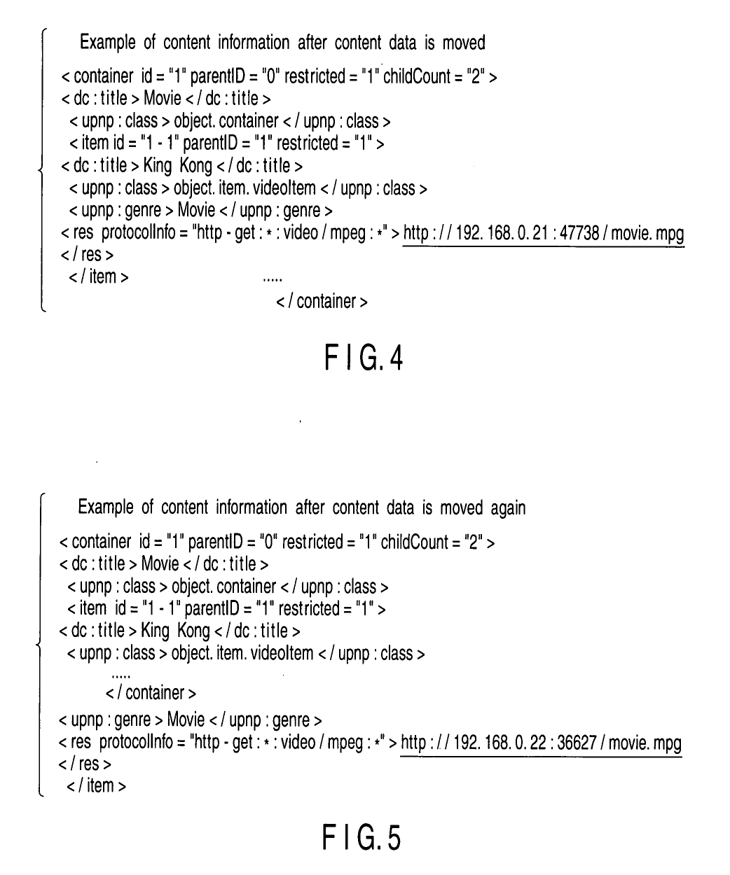

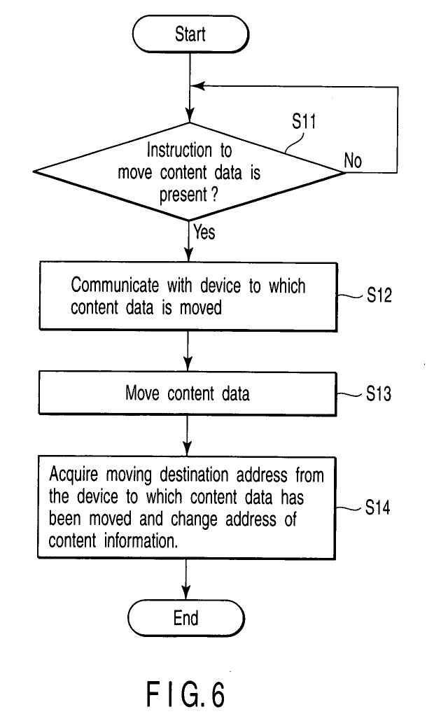

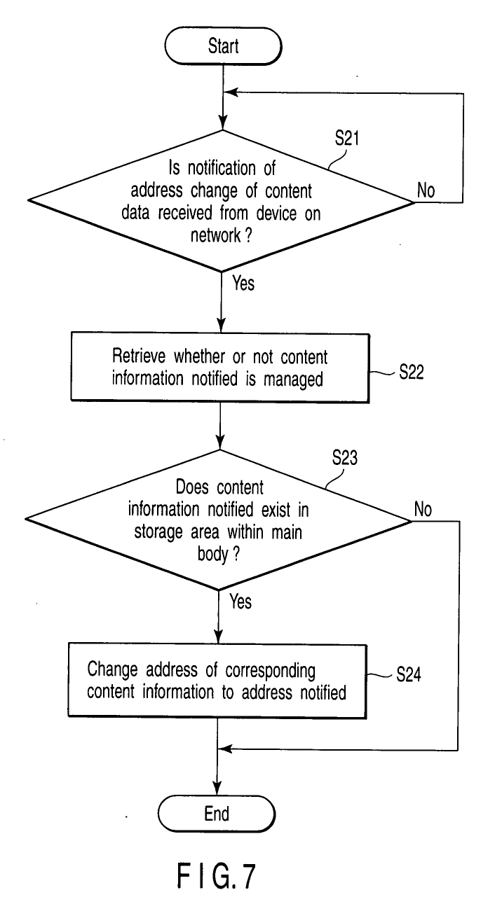

FIG. 1 is a block diagram showing an example of a configuration of the communication apparatus according to an embodiment of the present invention. FIG. 2 is an explanatory diagram showing an example of communication among a plurality of communication apparatuses according to the embodiment of the invention. FIG. 3 is an explanatory diagram showing an example of content information handled by the communication apparatus according to the embodiment. FIG. 4 is an explanatory diagram showing an example of the content information handled by the communication apparatus according to the embodiment. FIG. 5 is an explanatory diagram showing an example of the content information handled by the communication apparatus according to the embodiment. FIG. 6 is a flow chart showing an example of an address change notification processing after content data is moved in the communication apparatus according to the embodiment. FIG. 7 is a flow chart showing an example of the address change processing corresponding to the address change notification in the communication apparatus according to the embodiment.

Some apparatuses for digitizing broadcasting programs to record them have a function of transferring recorded content data to another device via network. Of them, content data requiring copyright protection needs to be transferred using copyright protection technology such as digital transmission contents protection over IP (DTCP-IP). In the digital transmission contents protection (DTCP), a processing called MOVE is defined in which in order to protect duplication of content data, content data on a transfer source is made unusable after the content data is transferred.

Conventionally, when the content data is moved via network, the content data at a transfer source is deleted. Thus, if a user forgets that some content data is moved to another device and accesses an original device in order to review the content data, he/she comes to know only that the content data is not present, which is inconvenient.

According to this embodiment, position information of content data before moving is updated to position information at a moving destination. Thus, even if the user attempts to operate the original device in order to review the content data, he/she can automatically access the content data at a place in which the content data exists regardless of whether the content data exists in the original device.

### Communication Apparatus According to an Embodiment of the Present Invention

(Configuration)

The communication apparatus of this embodiment can be carried out to those which transmit/receive content data through network by communication, and a hard disk recorder having two kinds of disk drive units will be exemplified here.

The communication apparatus 10 is connected to communication apparatuses 201 to 203 through a local area network (LAN) 101. In the meantime, the communication apparatuses 201 to 203 are assumed to have the same function as the communication apparatus 1, and description of these apparatuses is omitted.

As shown in FIG. 1, the communication apparatus 10 has an optical disk drive unit 19 which drives and rotates an optical disk D as a first medium which is an information recording medium capable of building up a video file so as to execute reading/writing of information. Further, the communication apparatus 10 has a hard disk drive unit 18 which drives a hard disk which is a second medium. A control unit 30 is connected to respective components via a data bus in order to control the entire operation.

The communication apparatus 10 in FIG. 1 includes as the main components, an encoder unit 21 which constitutes a recording side, a MPEG decoder unit 23 which constitutes a reproduction side, and a control unit 30 for controlling the operation of the apparatus main body.

The communication apparatus 10 has a selector unit 16 on the input side and a selector unit 17 on the output side. The selector unit 16 on the input side is connected with a communication unit 11 which executes communication with the LAN 101 or the like using Ethernet (registered trademark), a so-called satellite broadcasting (BS/CS) tuner unit 12, and a terrestrial tuner unit 13 and outputs a signal to the encoder unit 21. A satellite antenna is connected to the BS/CS tuner unit 12 and a terrestrial antenna is connected to the Terrestrial tuner unit 13.

The communication apparatus 10 comprises an encoder unit 21, a data editing unit 20 which executes a desired data processing such as data edition upon receipt of an output of the encoder unit 21, a hard disk drive unit 18 connected to the data editing unit 20, and an optical disk drive unit 19.

In the meantime, the communication apparatus 11 communicates with other communication apparatuses 201 to 203 via the LAN 11 according to universal plug and play (UPnP). A message described in an extensible markup language (XML) format is transmitted and received.

Additionally, the communication apparatus 10 further includes an MPEG decoder unit 23 which decodes upon receipt of signals from the hard disk drive unit 18 and the optical disk drive unit 19, an encoder unit 21, a buffer portion 22, a multiplexing unit 28, a separating unit 29, a control unit 30, a timer recording/program table generating unit 41, an encrypting/decrypting unit 42 and a content information managing unit 43 for managing meta data of the content data.

These respective units are connected to the control unit 30 via the data bus. Further, an output of the selector unit 17 is connected to an external receiver 40 or supplied to an external apparatus via an interface unit 27 for communicating with the external apparatus.

The encrypting/decrypting unit 42 executes a local encrypting/decrypting processing for content data when it accesses the hard disk drive unit 18 etc. which is a content storage portion, and also executes an encrypting/decrypting processing based on the DTCP or the like in transmission/receiving procedure with the communication unit 11.

The content information managing unit 43 manages meta data of content data which is stored in the hard disk drive unit 18 or the optical disk D and which can be accessed by the external communication apparatuses 201 to 203. The content information managing unit 43 presents the meta data as content directory service (CDS) to the external communication apparatuses 201 to 203 via the communication unit 11.

Even when the content data is moved from the hard disk drive unit 18 or the optical disk D to another communication apparatus (for example, communication apparatus 201), the content information managing unit 43 manages the meta data of the content data containing a uniform resource identifier (URI) after the moving.

The communication apparatus 10 is connected to the control unit 30 via a data bus, and has an operating unit 32 which receives user's operation or an operation of a remote controller R. The remote controller R enables substantially the same operation as the operating unit 32 provided on the main body of the communication apparatus 10 to be carried out, and can instruct on recording/reproduction in the hard disk drive unit 18 or the optical disk drive unit 19 and edition, operates the tuner, and executes various settings such as setting of timer recording.

(Operation)

Basic Operation

The reproduction processing and recording processing of the communication apparatus 10 having such a configuration will be described by exemplifying an optical disk. The optical disk D which is rotated at a predetermined velocity under the control of the control unit 30 is irradiated with laser beam, its reflection light is detected by an optical pickup, and then, a detection signal based thereon is outputted. An RF signal is generated based on the detection signal, and reproduction processing is carried out subsequent to data reading processing.

Data supplied from an input unit (not shown) via the selector unit 16 is supplied to the encoder unit 21. Where the data is an analog signal or it is recorded by use of another encoding method, the encoder unit 21 encodes the input data into digital data and outputs the digital data. In accordance with the coded output and an output of the control unit 30, a drive current of a laser driver is supplied to the optical pickup and irradiated on a storage area of the optical disk D so as to execute recording processing.

Recording Processing and the Like

Next, the operation of the communication apparatus 10 having such a configuration will be described in detail. First, mainly the operation thereof at the time of recording will be explained in detail including other embodiments. The communication unit 11 such as LAN is connected to an external device as an input side of the communication apparatus 10 so as to download content data or the like.

The BS/CS tuner unit 12 and the terrestrial tuner unit 13 select and demodulate a broadcasting signal via an antenna so as to input a video signal and an audio signal, and they correspond to a wide range of broadcasting signals. Examples of the broadcasting signals include terrestrial analog broadcasting, terrestrial digital broadcasting, BS analog broadcasting, BS digital broadcasting, and CS digital broadcasting, but not limited thereto. The communication apparatus is not always provided with a single one of those, but may include two or three units of the terrestrial analog broadcasting tuner units or BS/CS tuner units, which may be operated in parallel to meet demand for timer recording of programs.

The communication unit 11 may be an IEEE 1394 interface and other interfaces and can receive content data from any external device on the network. Further, they, for example, may receive video signals and audio signals such as a brightness signal, a color-difference signal and a composite signal from an input terminal (not shown). The input of these signals is controlled by the selector unit 16 controlled by the control unit 30 or the like, and the inputted signals are supplied selectively to the encoder unit 21.

The encoder unit 21 includes video and audio analog/digital converters for digitizing an analog video signal and an analog audio signal inputted by the selector unit 16, a video encoder and an audio encoder. The encoder unit 21 also includes an auxiliary video encoder. Output of the encoder unit 21 is converted to a predetermined compression format such as MPEG and supplied to the control unit 30.

The BS/CS tuner 12 or the like does not need to be always incorporated, but may be externally provided via a data input terminal so as to supply received digital signals to the encoder unit 21 or the control unit 30 via the selector unit 16.

The apparatus of FIG. 1 can supply information (pack of video, audio, auxiliary video data) encoded by the encoder unit 21 and created management information to the hard disk drive unit 18 or the optical disk drive unit 19 via the control unit 30 to thereby record such information in the hard disk drive unit 18 or the optical disk D. Further, the information recorded in the hard disk drive unit 18 or the optical disk D can be recorded in the optical disk D or the hard disk drive unit 18 via the control unit 30 and the optical disk drive unit 19.

Edit Processing and the Like

The data editing unit 20 can execute an editing processing by partially deleting video objects of plural programs recorded in the hard disk drive unit 18 or the optical disk D or combining objects of different programs.

Reproduction Processing and the Like

Next, a processing of reproducing mainly recorded information will be described in detail including other embodiments. The MPEG decoder unit 23 has a video processor which appropriately synthesizes a decoded sub-picture with a decoded main picture and superimposes a menu, highlight button, caption and other sub-pictures on the main picture.

An output audio signal of the MPEG decoder unit 23 is analog-converted by a digital/analog converter (not shown) via the selector unit 17 and supplied to a speaker or supplied to an external unit via an I/F unit 27. The selector unit 17 is controlled by a select signal from the control unit 30. Consequently, the selector unit 17 can select a signal coming through the encoder unit 21 when directly monitoring digital signals from the respective tuner units 12 and 13.

Timer Recording Processing

Next, a timer recording processing can be carried out corresponding to a program specified by user's operation with a remote controller based on electronic program information acquired from the communication unit 11 or the like. When a reservation time reaches, the control unit 30 and the timer recording unit 41 are actuated based on the timer recording information so that video/audio signals produced by demodulating program information received by the BS/CS tuner unit 12 or the terrestrial tuner unit 13 is subjected to an encoding processing by the encoder 21 and then recorded (timer recorded) in the hard disk drive unit 18, for example.

The communication apparatus 10 of this embodiment has such a general function and executes the recording/reproduction processing by the optical disk D or hard disk drive unit 18 to a number of sources. Next, content information management processing of the communication apparatus 10 will be described in detail with reference to the drawings.

Example of Content Information Management Processing of Communication Apparatus of an Embodiment of the Invention

Next, an example of the content information management processing of the communication apparatus of the embodiment of the invention will be described in detail.

Outline

The communication apparatus 10 of this embodiment is configured as follows. Even if content data is moved from the communication apparatus 10 to the communication apparatus 201 and then from the communication apparatus 201 to the communication apparatus 202 as shown in FIG. 2, the content information managing unit 43 of the communication apparatus 10 always holds a URI which is position information for accessing the content data as meta data, and also has a function of updating the URI accompanied with the movement.

Another apparatus (for example, communication apparatus 203) can access content data by acquiring a current URI of the content data by a CDS provided by the content information managing unit 43.

As shown in FIG. 2, assume that IP addresses of the communication apparatus 10, the communication apparatus 201 and the communication address 202 are (192. 168. 0.20), (192. 168. 0.21) and (192. 168. 0.22).

Even if content data is moved as described above, content information (container) concerning the content data presented by the content information managing unit 43 of the communication apparatus 10 on the communication apparatus 10 as CDS is not deleted. The content information presented by the communication apparatus 10 is changed from the state of FIG. 3 to states shown in FIGS. 4 and 5.

In an example of description of the content information in FIGS. 3, 4 and 5, the URI for accessing the content data is described below res property.

In FIG. 3 in which the content data is stored in the communication apparatus 10 before the content data is moved, the URI is started from “192. 168. 0.20” which is the IP address of the communication apparatus 10. “58849” following beyond “:” is a port number for use, and “movie.mpg” indicates a file name of the content data.

Next, if the content data is moved from the communication apparatus 10 to the communication apparatus 201, as shown in FIG. 4, the URI below the res property is changed to “192. 168. 0.21” which is the IP address of the communication apparatus 201 and the port number for use is also changed to “47738”. The URI information becomes evident when it is received from the communication apparatus 201 which is a moving destination as described later.

Further, if the content data is moved from the communication apparatus 201 to the communication apparatus 202, as shown in FIG. 5, the URI below res property is changed to “192. 168. 0.22” which is the IP address of the communication apparatus 203 and the port number for use is also changed to “36627”. The URI information becomes evident when it is received from the communication apparatus 202.

Consequently, when the communication apparatus 203 instructs upon reproduction of the content data, the communication apparatus 10 can acquire the URI presented by the content information managing unit 43 as the CDS regardless of whether or not the content data is actually stored in the communication apparatus 10. Thus, the content data can be reproduced.

Hereinafter, these processings will be described using a flow chart.

Address Change Notification Processing

First, consider a case of moving the content data from the communication apparatus 10 to the communication apparatus 201 in FIG. 2. In the meantime, as described previously, the communication unit 11 communicates with another communication apparatus through UPnP.

In the communication apparatus 10, if an instruction of moving the content data is given from the communication unit 11 or the operating unit 32 to the content data stored in the hard disk drive unit 18 or the optical disk D (step S11), the communication apparatus 10 communicates with the communication apparatus 201 which is a moving destination device by the communication unit 11, the content information managing unit 43 and the like under the control of the control unit 30 so as to perform an authentication processing or the like (step S12). If the content data is allowed to be moved as a result of the authentication, the content data is moved to the communication apparatus 201 under the control of the control unit 30 (step S13).

More specifically, if the communication unit 11 receives an instruction of moving, the control unit 30 controls respective blocks and the control unit 30 reads the content data from the data editing unit 20. Then, the read data is decoded by the encrypting/decrypting unit 42 and the decoded data is subjected to encoding by the DTCP-IP or the like. Then, the content data is transferred to the communication apparatus 201 via the communication unit 11.

After the content data is transferred, the content data is made unusable in a storage medium (optical disk D or hard disk drive unit 18).

The communication apparatus 201 which is a moving destination device notifies (advertises) all the devices existing on the network of a new URI for accessing the content data by broadcasting or multi-casting.

Then, the control unit 30 and the content information managing unit 43 of the communication apparatus 10 change the URI of the content data controlled by its own content information managing unit 43 as shown in an example of FIG. 4 by means of the URI of a moving destination received from the device at the moving destination (step S14).

If a request arises from another communication apparatus (for example, communication apparatus 203), the content information managing unit 43 notifies of (presents) content information concerning the content data in a format shown in FIG. 4.

Address Update Processing Based on Address Change Notification

Next, a processing of the communication apparatus 10 in case where a notification of URI change of content data is received when the content data is moved from the communication apparatus 201 to the communication apparatus 202 will be described with reference to a flow chart of FIG. 7. As described above, the communication unit 11 communicates with another communication apparatus through the UPnP.

If the control unit 30 and the content information managing unit 43 receive a notification of a new URI from any device on the network accompanied by moving of the content data, the control unit 30 and the content information managing unit 43 detect this (step S21). The new URI information accompanied by the moving is notified (advertised) by the communication apparatus 202 which is a device at the moving destination as described above to respective devices on the network by broadcasting or the like.

Then, the content information managing unit 43 retrieves whether or not meta data of the content data concerning the notification of the URI change is managed within the content information managing unit 43 (step S22).

If the content information of the notified content data is managed by the content information managing unit 43 (Yes in step S23), the URI of the content information of corresponding content data is changed to the notified URI (step S24).

That is, the content information managed by the content information managing unit 43 of the communication apparatus 10 is updated from FIG. 4 to FIG. 5 accompanied by moving of the content data from the communication apparatus 202 to the communication apparatus 203. In other words, the communication apparatus 10 updates the content information upon receipt of a URI change notification each time when the content data is moved even if the communication apparatus 10 is not concerned with the moving. Thus, each communication apparatus can recognize a currently latest storage position of the content data managed by the content information managing unit 43.

(Reproduction Processing Using Content Address)

On the other hand, preferably, the control unit 30 and the content information managing unit 43 display a list or the like of the content data on, for example, a display unit 33 based on address information of the content data managed by the content information managing unit 43 in the same way as for the content data stored therein (or to differentiate the content data stored therein).

Consequently, the user can reproduce the content data by giving an instruction on reproduction thereof without being conscious of a location of the content data. That is, if an operating signal about reproduction of the reproducible content data is received via the operating unit 32 or the like, the control unit 30 and the content information managing unit 43 are supplied with the content data from an external device in which the content data exists via the communication unit 11. Then, the content data is reproduced by a function of the reproducing unit such as the MPEG decoder 23.

The content information managed by the content information managing unit 43 is notified to the external communication apparatuses 201 to 203 via the communication unit 11 as the CDS on demand. Because the content information managing unit 43 also notifies of a URI of the content information concerning the content data moved to other communication apparatuses from the storage medium D or the hard disk drive unit 18, the content information can be reproduced in the communication apparatuses 201 to 203 by accessing the URI.

Consequently, according to the communication apparatus of this embodiment, the following advantage is obtained. If content data of a certain device is moved to another device via the network, the content data at a current position can be specified and reproduced when the user specifies the content data through an operating screen or the like of the device before moving by replacing the position information of content data before moving with information at the moving destination.

In the communication apparatus of this embodiment, the following advantage is also provided. When content data is moved, the device at a movement destination of the content data notifies (advertises) all the devices existing on the network that the content data has been moved. If there exists corresponding content information, the devices on the network update the content information to the latest position information (URI) in response to this notification. As a consequence, even if the content data is moved plural times, all network-type content distribution apparatuses can be made to accurately update the current content data position information.

Because each communication apparatus can always recognize position information of the latest content data even if it does not possess content data itself, it can reproduce the latest content data with the same feeling of operation as for content data possessed by itself.

According to various embodiments described above, those skilled in the art can achieve the present invention, and further can conceive various modifications of these embodiments easily. They can apply the invention to various embodiments without any inventive ability. Therefore, the present invention covers a wide range not contracting with the disclosed principle and novel features, and is not restricted to the above-described embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus comprising:
a reading unit which reads content data from a storage medium;
a communication unit which communicates with a first external unit and a second external unit via network;
a notifying unit which notifies, via the communication unit, the first external unit of position information for accessing content data that is readable by the reading unit; and
a moving unit which moves the content data read by the reading unit to the second external unit via the communication unit, wherein
after the moving unit moves the content data to the second external unit, the notifying unit notifies, via the communication unit, the first external unit of position information concerning the second external unit for accessing the content data as position information of the content data.

2. The communication apparatus according to claim 1, wherein when a change notification of the position information of the content data is received via the communication unit, position information after the change is notified to the first communication unit as the position information of the content data.

3. The communication apparatus according to claim 1, wherein the position information which is notified by the notifying unit is URI for accessing content data.

4. The communication apparatus according to claim 1, wherein the communication unit communicates with the first external unit and the second external unit via the network according to the UPnP communication standard, and
the notifying unit notifies of the position information of the content data as CDS.

5. A communication method comprising:
notifying, via network, a first external unit of position information for accessing content data that is readable from a storage medium;
moving the content data read from the storage medium to a second external unit via network; and
after the content data is moved, notifying, via the network, the first external unit of position information concerning the second external unit for accessing the content data as the position information of the content data.

6. The communication method according to claim 5, wherein upon receipt of a change notification of the position information of the content data via the network, the position information after the change is notified to the first communication unit as the position information of the content data.

7. The communication method according to claim 5, wherein the position information to be notified is URI for accessing the content data.

8. The communication method according to claim 5, wherein the communication of the content data between the first external unit and the second external unit via the network is carried out according to the UPnP communication standard, and
the position information of the content data is notified as CDS.
